(19) United States
(12) Patent Application Publication
(10) Pub. No.: US 2025/0020897 A1
(43) Pub. Date: Jan. 16, 2025

(54) ZOOM LENS AND IMAGE PICKUP APPARATUS

(71) Applicant: CANON KABUSHIKI KAISHA, Tokyo (JP)

(72) Inventor: Junya ICHIMURA, Tochigi (JP)

(21) Appl. No.: 18/754,614

(22) Filed: Jun. 26, 2024

(30) Foreign Application Priority Data
Jul. 12, 2023 (JP) 2023-114131

(51) Int. Cl. G02B 15/14; G02B 15/167; G02B 15/177

(52) U.S. Cl. CPC G02B 15/1465; G02B 15/167; G02B 15/177

(57) ABSTRACT

A zoom lens includes a plurality of lens units. The plurality of lens units consist of, in order from an object side to an image side, a first lens unit having negative refractive power, an intermediate group having positive refractive power, the intermediate group including two or more lens units, an aperture stop, and a rear group including at least one lens unit. A distance between adjacent lens units changes during zooming from a wide-angle end to a telephoto end. The intermediate group includes a first focus unit and a second focus unit that move during focusing from infinity to a close distance.

### BACKGROUND

### Technical Field

One of the aspects of the embodiments relates to a zoom lens and an image pickup apparatus.

### Description of Related Art

Japanese Patent Laid-Open No. 6-235862 discloses a zoom lens configured to move a first lens unit toward the object side and a second lens unit toward the object side during focusing to reduce changes in an angle of view. Japanese Patent Laid-Open No. 2021-15195 discloses a zoom lens that includes two focus units, a focus unit in a first lens unit and a focus unit in a final lens unit, and switches the focus unit to be moved during focusing according to a zoom position.

The zoom lens disclosed in Japanese Patent Laid-Open No. 6-235862 performs correction by zooming using a zoom cam, so correction is difficult with a configuration such as an interchangeable lens that cannot perform electric zoom. The zoom lens disclosed in Japanese Patent Laid-Open No. 2021-15195 moves the focus lens in the first lens unit, which has a large lens diameter and heavy weight, and thus has difficulty in electrification and reducing changes in the angle of view over the entire zoom range. It is thus difficult for the configurations disclosed in Japanese Patent Laid-Open Nos. 6-235862 and 2021-15195 to realize a zoom lens with high optical performance.

### SUMMARY

A zoom lens according to one aspect of the disclosure includes a plurality of lens units. The plurality of lens units consist of, in order from an object side to an image side, a first lens unit having negative refractive power, an intermediate group having positive refractive power, the intermediate group including two or more lens units, an aperture stop, and a rear group including at least one lens unit. A distance between adjacent lens units changes during zooming from a wide-angle end to a telephoto end. The intermediate group includes a first focus unit and a second focus unit that move during focusing from infinity to a close distance. An image pickup apparatus having the above zoom lens also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of a zoom lens according to Example 1.

FIG. 2 is a sectional view of a zoom lens according to Example 2.

FIG. 3 is a sectional view of a zoom lens according to Example 3.

FIG. 4 is a sectional view of a zoom lens according to Example 4.

FIGS. 5A and 5B are longitudinal aberration diagrams of the zoom lens according to Example 1.

FIGS. 6A and 6B are longitudinal aberration diagrams of the zoom lens according to Example 2.

FIGS. 7A and 7B are longitudinal aberration diagrams of the zoom lens according to Example 3.

FIGS. 8A and 8B are longitudinal aberration diagrams of the zoom lens according to Example 4.

FIG. 9 is a schematic diagram of an image pickup apparatus having a zoom lens according to each example.

### DESCRIPTION OF THE EMBODIMENTS

Referring now to the accompanying drawings, a detailed description will be given of embodiments according to the disclosure.

A zoom lens (optical system) according to each example includes, in order from an object to an image side, a first lens unit B1 having negative refractive power, a plurality of lens units having positive refractive power (positive lens unit), an aperture stop (diaphragm) STO, and a rear group including at least one lens unit. A distance between adjacent lens units changes during zooming from a wide-angle end to a telephoto end. The plurality of lens units (positive lens unit) include a first focus unit F1 and a second focus unit F2 that move during focusing from infinity to a close distance (short distance). That is, the zoom lens according to each example performs focusing using two positive lens units (first focus unit F1 and second focus unit F2) disposed on the object side of the aperture stop STO.

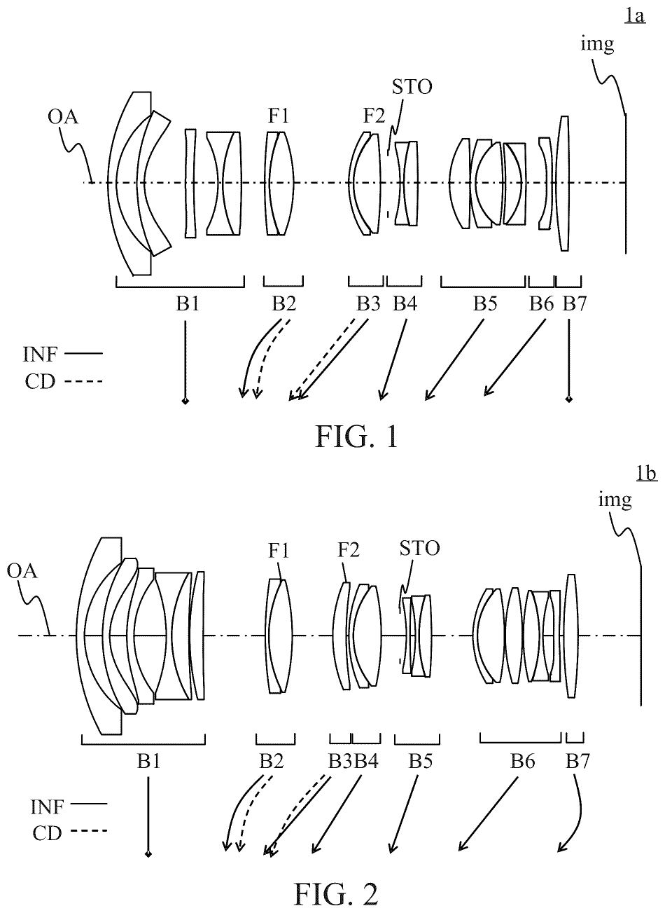

FIG. 1 is a sectional view of the zoom lens 1a according to Example 1. In FIG. 1, a left side is an object side, and a right side is an image side. The zoom lens 1a is a large-diameter wide-angle zoom lens, and includes, in order from the object side to the image side, a first lens unit B1 having negative refractive power, a second lens unit B2 having positive refractive power, and a third lens unit B3 having positive refractive power, an aperture stop STO, and a rear group. The rear group include, in order from the object side to the image side, a fourth lens unit B4 having negative refractive power, a fifth lens unit B5 having positive refractive power, a sixth lens unit B6 having negative refractive power, and a seventh lens unit B7 having positive refractive power.

During zooming, the first lens unit B1 and the seventh lens unit B7 are fixed, and the second lens unit B2 to the sixth lens unit B6 move toward the object side. The zoom lens 1a according to this example has an overall length that does not change during zooming, thus is less likely to change the center of gravity, and is beneficial in dust resistance. In addition, the zoom lens 1a has a low zoom torque and is easily compatible with a retrofitted electric zoom attachment, and is suitable for use in motion image capturing applications.

During focusing, the second lens unit B2 is set as the first focus unit F1, the third lens unit B3 is set as the second focus unit F2, and the first focus unit F1 and the second focus unit F2 are moved in a direction along the optical axis OA (optical axis direction). Now assume that the one with higher focus sensitivity during movement as a focus unit and the other with lower focus sensitivity as a floating unit. Then, the focus unit is the first focus unit F1, and the floating unit is the second focus unit F2 in this example.

In the zoom lens 1a according to this example, during focusing from infinity (INF) to a close distance (CD) at the wide-angle end, the second lens unit B2 (first focus unit F1) and the third lens unit B3 (second focus unit F2) are moved in different directions. More specifically, during focusing from infinity to a close distance, the second lens unit B2 (first focus unit F1) moves toward the image side, and the third lens unit B3 (second focus unit F2) moves toward the object side. Focusing is performed by moving the second lens unit B2 toward the image side, but at the same time a change in focal length occurs and the angle of view changes, so moving the third lens unit B3 toward the object side can cancel changes in the angle of view.

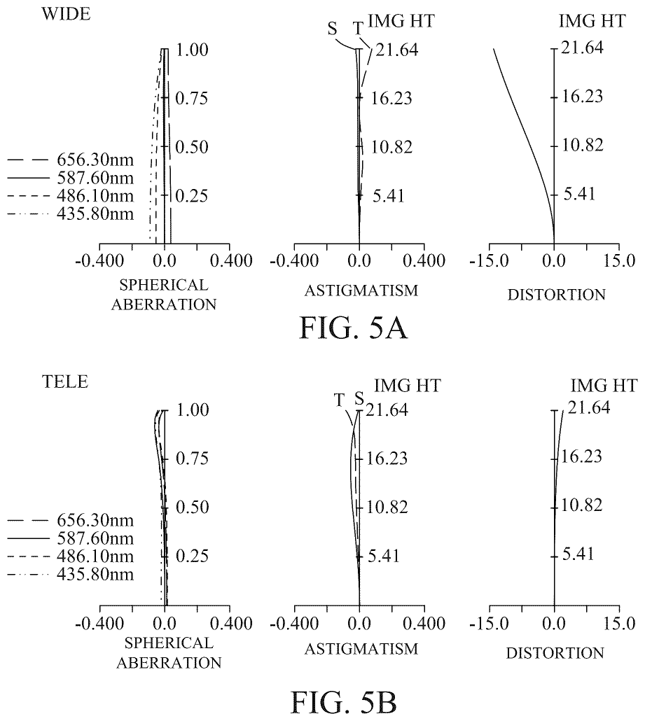

FIG. 5A illustrates a longitudinal aberration diagram of the zoom lens 1a at the wide-angle end, and FIG. 5B illustrates a longitudinal aberration diagram of the zoom lens 1a at the telephoto end. FIGS. 5A and 5B illustrate excellent optical performance obtained in a range from the wide-angle end to the telephoto end.

In each example, during focusing from infinity to a close distance at the wide-angle end, the following inequality (1) may be satisfied:

$$0. < \vert mo 2 w \vert / \vert mo 1 w \vert < 1. \qquad ( 1 )$$

where mo1w is a moving amount of the first focus unit F1, and mo2w is a moving amount of the second focus unit F2.

Inequality (1) defines a ratio of the moving amount of the focus unit and the floating unit during focusing, and the moving amount of the floating unit may be reduced relative to that of the focus unit. In a case where the value becomes lower than the lower limit of inequality (1), the effect of reducing angle of view fluctuations cannot be obtained. In a case where the value becomes higher than the upper limit of inequality (1), zoom movement is restricted and is likely to increase the overall length.

Inequality (1) may be replaced with inequality (1a) below:

$$0.1 < \vert mo 2 w \vert / \vert mo 1 w \vert < 0.9 \qquad ( 1 a )$$

Inequality (1) may be replaced with inequality (1b) below:

$$0.15 < \vert mo 2 w \vert / \vert mo 1 w \vert < 0. 80 \qquad ( 1 b )$$

The following inequality (2) may be satisfied:

$$0. < movF 1 / TTL < 0.15 \qquad ( 2 )$$

where movF1 is a zoom moving amount of the first focus unit F1 relative to the first lens unit B1 (the moving amount during zooming from the wide-angle end to the telephoto end), and TTL is a distance from the lens surface closest to the object side of the zoom lens to the image plane.

Inequality (2) defines a range of the relative position of the first focus unit F1. By zooming at a position close to the first lens unit B1, which has negative refractive power, the first focus unit F1 contributes to magnification variation, can easily obtain high focus sensitivity, and reduce changes in the angle of view in a case where the first focus unit F1 solely moves. In a case where the value becomes lower than the lower limit of inequality (2), a moving amount of the first focus unit F1 is reduced, and it becomes difficult to satisfactorily reduce spherical aberration fluctuations due to zooming. On the other hand, in a case where the value becomes higher than the upper limit of inequality (2), moving loci of the first focus unit F1 and the second focus unit F2 become closer, and it becomes difficult to achieve the effect of reducing changes in the angle of view.

Inequality (2) may be replaced with inequality (2a) below:

$$0.02 < movF 1 / TTL < 0.13 \qquad ( 2 a )$$

Inequality (2) may be replaced with inequality (2b) below:

$$0.03 < movF 1 / TTL < 0.12 \qquad ( 2 b )$$

In each example, the following inequality (3) may be satisfied:

$$0.2 < ff / fr < 1. \qquad ( 3 )$$

where ff is a combined focal length of lens units of the zoom lens disposed on the object side of the aperture stop STO, and fr is a combined focal length of lens units disposed on the image side of the aperture stop STO.

Inequality (3) defines a ratio of the focal length of the lens unit on the object side of the aperture stop STO to the focal length of the lens unit on the image side of the aperture stop STO. Satisfying inequality (3) can reduce fluctuations in the angle of view even in a case where the aperture in the aperture stop STO is narrowed while disposing the first focus unit F1 and the second focus unit F2. In a case where the value becomes higher than the upper or lower than the lower limit of inequality (3), off-axis principal rays tend to deviate from the center of the aperture stop, and in the case where the aperture in the aperture stop STO is narrowed, the angle of view fluctuates significantly due to the influence of one-sided aperture.

Inequality (3) may be replaced with inequality (3a) below:

$$0.23 < ff / fr < 0.80 \qquad ( 3 a )$$

Inequality (3) may be replaced with inequality (3b) below:

$$0. 25 < ff / fr < 0.60 \qquad ( 3 b )$$

The following inequality (4) may be satisfied:

$$0.3 < fF 1 / fF 2 < 1.7 \qquad ( 4 )$$

where fF1 is a focal length of the first focus unit F1 and fF2 is a focal length of the second focus unit F2.

Inequality (4) defines a ratio of the focal length of the first focus unit F1 to the focal length of the second focus unit F2. Satisfying inequality (4) can provide the effect of reducing changes in the angle of view caused by zooming and focusing while suppressing an increase of the overall length. In a case where the value becomes higher than the upper limit of inequality (4), a focus moving amount (a moving amount during focusing) of the first focus unit F1 becomes too large, and the fluctuation in the angle of view during focusing becomes large. In a case where the value becomes lower than the lower limit of inequality (4), the magnification varying effect of the second focus unit F2 becomes too small, a zoom moving amount (a moving amount during zooming) becomes large, and the overall lens length increases.

Inequality (4) may be replaced with inequality (4a) below:

$$0.4 < fF 1 / fF 2 < 1.5 \qquad ( 4 a )$$

Inequality (4) may be replaced with inequality (4b) below:

$$0.5 < fF 1 / fF 2 < 1.3 \qquad ( 4 b )$$

A general wide-angle zoom moves the first lens unit B1, thereby performing image point correction through extending the entire lens unit. In a case where the first lens unit B1 is fixed, the image point correction function reduces, so the zoom lens may include a negative lens unit on the image side of the aperture stop STO, and a positive lens unit that moves from the image side to the object side during magnification variation, wherein a distance may be changed between adjacent lens units during zooming.

In each example, in order to reduce the overall length, a lens unit having positive refractive power may be disposed closest to the image plane of the zoom lens (lens unit in the rear group). Each example may satisfy the following inequality (5):

$$0. 2 < BFw / fw < 2.0 \qquad ( 5 )$$

where BFw is an air equivalent length of the back focus at the wide-angle end, and fw is a focal length of the zoom lens at the wide-angle end.

Inequality (5) defines a relationship of back focus to focal length. In a case where the value becomes higher than the upper limit of inequality (5), the back focus becomes too long relative to the focal length and the overall length becomes too long. On the other hand, in a case where the value becomes lower than the lower limit of inequality (5), the back focus is too short and the lens, lens barrel, and sensor tend to interfere with each other.

Inequality (5) may be replaced with inequality (5a) below:

$$0.5 < BFw / fw < 1.5 \qquad ( 5 a )$$

Inequality (5) may be replaced with inequality (5b) below:

$$0.8 < BFw / fw < 1.3 \qquad ( 5 b )$$

FIG. 2 is a sectional view of the zoom lens 1b according to Example 2. In FIG. 2, a left side is an object side, and a right side is an image side. The zoom lens 1b is a large-diameter wide-angle zoom lens, and includes, in order from the object side to the image side, a first lens unit B1 having negative refractive power, a second lens unit B2 having positive refractive power, a third lens unit B3 having positive refractive power, a fourth lens unit B4 having positive refractive power, an aperture stop STO, and a rear group. The rear group includes, in order from the object side to the image side, a fifth lens unit B5 having negative refractive power, a sixth lens unit B6 having positive refractive power, and a seventh lens unit B7 having positive refractive power.

The zoom lens 1b according to this example is of a type that has a wider focal length range at the wide-angle end and a wider focal length range at telephoto end than those of the zoom lens 1a according to Example 1, and even if the focal length range is expanded, this zoom lens can reduce changes in the angle of view due to focusing. In addition, the second lens unit B2 is set as a focus unit (first focus unit F1), and the third lens unit B3 is set as a floating unit (second focus unit F2), and the variator unit is divided and a magnification varying function and a floating function are separately assigned to them. Thereby, the weight of the focus moving unit and zoom fluctuations can be reduced.

During zooming, similarly to Example 1, both the first focus unit F1 and the second focus unit F2 move toward the object side. During focusing from infinity to a close distance, the angle-of-view fluctuations can be suppressed by moving the first focus unit F1 toward the image side and by moving the second focus unit F2 toward the object side, similarly to Example 1, in a range from the wide-angle end to an intermediate zoom position. At the telephoto end, both the first focus unit F1 and the second focus unit F2 move toward the image side in order to secure a short distance and reduce the overall length. In this case, at the telephoto end, the change in the angle of view is not zero, but it is a sufficiently small amount, and at the wide-angle end where the change in the angle of view is more noticeable, the change in the angle of view can be corrected to a value close to zero.

FIG. 3 is a sectional view of the zoom lens 1c according to Example 3. In FIG. 3, a left side is an object side, and a right side is an image side. The zoom lens 1c is a large-diameter wide-angle zoom lens, and includes, in order from the object side to the image side, a first lens unit B1 having negative refractive power, a second lens unit B2 having positive refractive power, a third lens unit B3 having positive refractive power, a fourth lens unit B4 having positive refractive power, an aperture stop STO, and a rear group. The second lens unit B2 is set as the first focus unit F1, and the fourth lens unit B4 is set as the second focus unit F2. The rear group includes, in order from the object side to the image side, a fifth lens unit B5 having negative refractive power, a sixth lens unit B6 having positive refractive power, a seventh lens unit B7 having negative refractive power, and an eighth lens unit B8 having positive refractive power. The zoom lens 1c according to this example has a much wider focal length range at the wide-angle end than that of the zoom lens 1a according to Example 1, and reduces changes in the angle of view caused by focusing even on a wider-angle scheme.

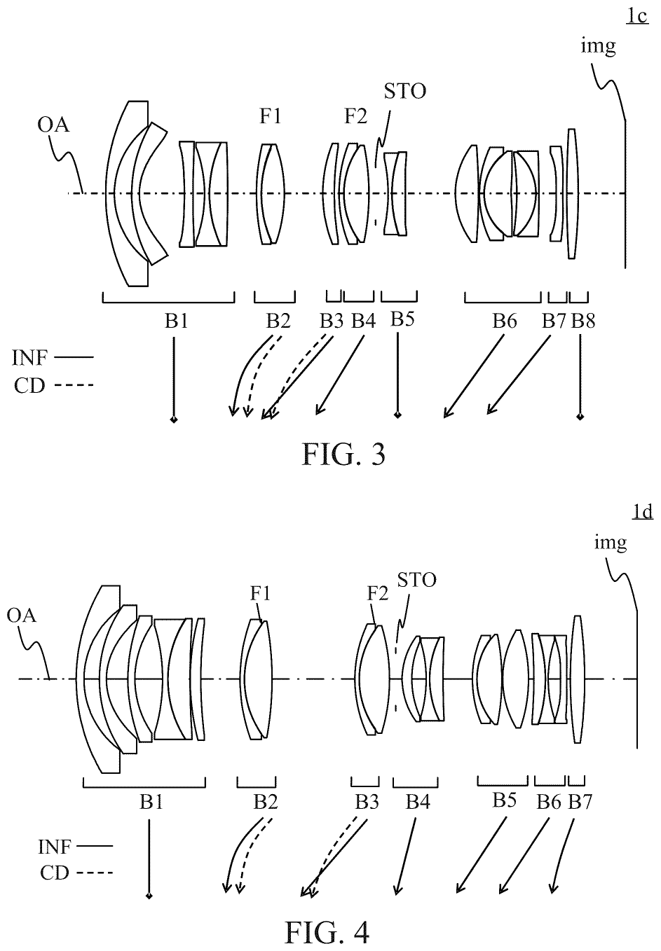

FIG. 4 is a sectional view of the zoom lens 1d according to Example 4. In FIG. 4, a left side is an object side, and a right side is an image side. The zoom lens 1d is a large-diameter wide-angle zoom lens, and includes, in order from the object side to the image side, a first lens unit B1 having negative refractive power, a second lens unit B2 having positive refractive power, a third lens unit B3 having positive refractive power, an aperture stop STO, and a rear group. The rear group includes, in order from the object side to the image side, a fourth lens unit B4 having negative refractive power, a fifth lens unit B5 having positive refractive power, a sixth lens unit B6 having negative refractive power, and a seventh lens unit B7 having positive refractive power. The zoom lens 1d according to this example is of a type that has a wider focal length range at the wide-angle end and a wider focal length range at the telephoto end than those of the zoom lens 1a according to Example 1, and this zoom lens can reduce changes in the angle of view caused by focusing even in a case where the focal length range is expanded.

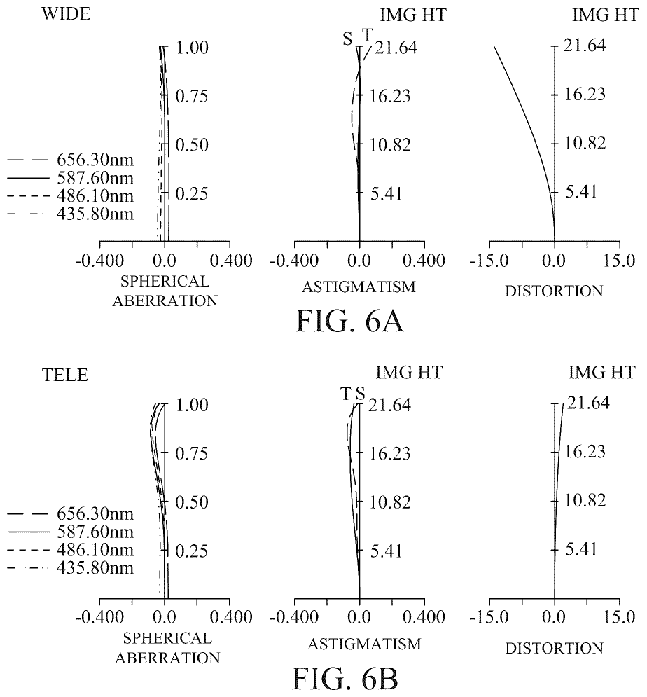

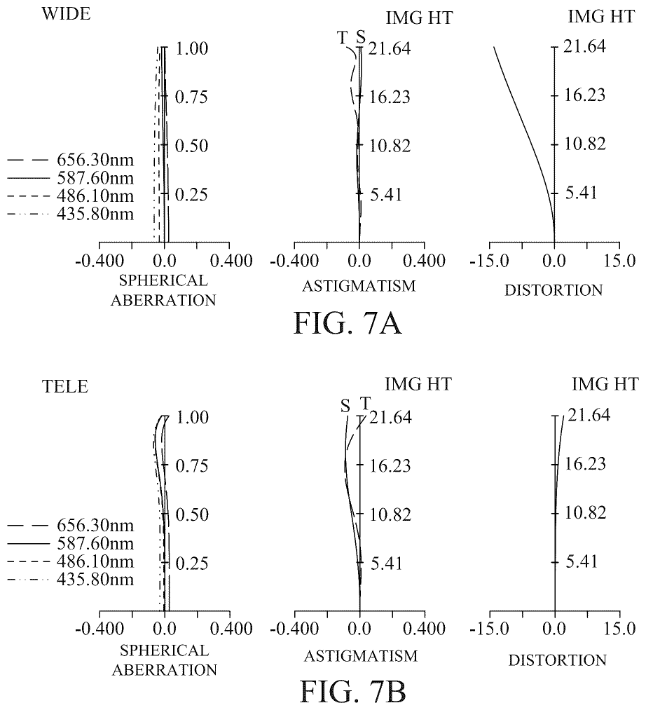

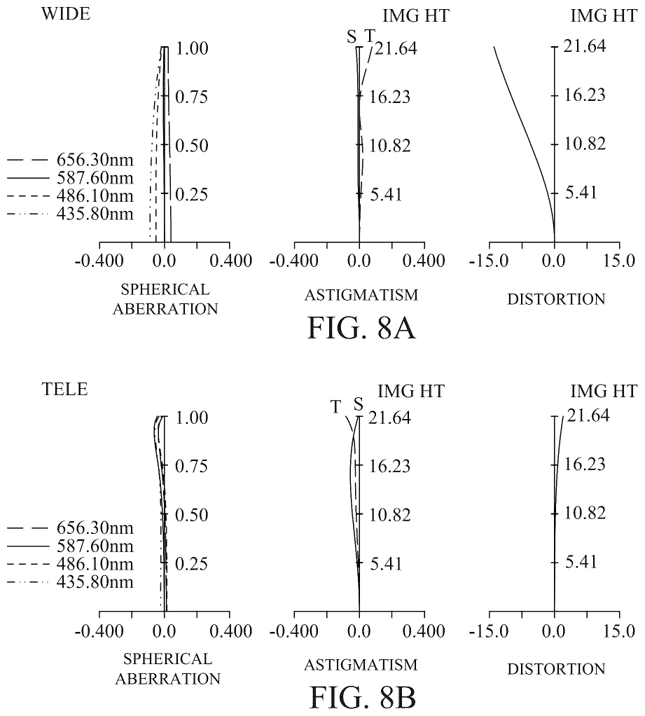

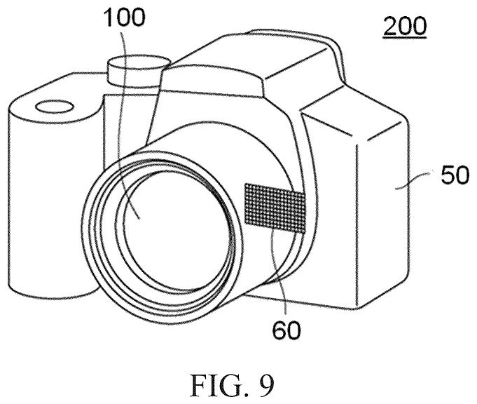

FIGS. 5A, 5B, 6A, 6B, 7A, 7B, 8A, and 8B are longitudinal aberration diagrams illustrating the imaging performance of the zoom lenses 1a to 1d according to Examples 1 to 4. In each aberration diagram, each of FIGS. 5A, 6A, 7A, and 8A illustrate an aberration diagram at the wide-angle end, each of FIGS. 5B, 6B, 7B, and 8B illustrates an aberration diagram at the telephoto end, and each aberration diagram illustrates from the left side, spherical aberration, astigmatism, and distortion. In the spherical aberration diagram, a solid line illustrates a spherical aberration amount for the d-line (587.56 nm), a broken line illustrates a spherical aberration amount for the F-line (486.13 nm), a rough broken line illustrates a spherical aberration amount for the C-line (656.27 nm), and an alternate long and two short dashes line illustrates a spherical aberration amount for the g-line (435.83 nm). The scale on the horizontal axis represents a defocus amount, which ranges −0.4 [mm] to +0.4 [mm]. In the astigmatism diagram, a solid line illustrates an astigmatism amount on a sagittal image plane, and a dotted line illustrates an astigmatism amount on a meridional image plane. The scale of the horizontal axis is similar to that of the spherical aberration diagram. In the distortion diagram, the scale on the horizontal axis ranges −15 [mm] to +15 [%].

A description will now be given of numerical examples 1 to 4 corresponding to Examples 1 to 4. In each numerical example, a surface number is a number assigned to a surface of each lens in order from the magnification side in each numerical example. r represents a radius of curvature (mm) of each lens surface, d represents a surface distance (mm), and a surface distance in a parenthesis indicates a unit distance. nd and vd represent a refractive index and an Abbe number of a glass material for the d-line (587.56 nm).

A lens surface with an asterisk (*) attached to the right of the surface number indicates that it has an aspherical shape according to the following function, and its coefficients are illustrated in the numerical examples. y indicates a coordinate in a radial direction based on the vertex of the lens surface, and x indicates a coordinate in the optical axis direction based on the vertex of the lens surface. R is a paraxial radius of curvature, K is a conical constant, and A, B, C, D, and F are aspherical coefficients of each order:

$$x = ( {y}^{2} / R ) / [ 1 + {\{ 1 - ( 1 + K ) ( {y}^{2} / {R}^{2} ) \}}^{1 / 2} ] + {Ay}^{4} + {By}^{6} + {Cy}^{8} + {Dy}^{10} + {Fy}^{12}$$

In various data tables, a focal length and F-number (aperture value) are listed as values in an in-focus state at an infinity object distance. AOV represents an angle of view. An image height indicates a paraxial image height (PIH) and a real image height (RIH), and each example assumes that image distortion caused by distortion (aberration) is corrected by processing the captured image. An overall lens length indicates a distance from a first surface of the lens to the image position. BF represents back focus, which is an air equivalent length as a distance from a lens having refractive power disposed closest to an image plane IP to the image plane IP, and if there is an element that does not have refractive power such as a flat plate in this space, BF is calculated by excluding that element. In distance (or interval) data, OBJ indicates an object distance, which is expressed as a distance from an object position to the image plane IP. Fno represents an F-number. WIDE represents the wide-angle end, MIDDLE represents an intermediate (middle) zoom position, TELE represents a telephoto end. “e±XX” in each aspherical coefficient means “×10^{±XX}.”

NUMERICAL EXAMPLE 1
UNIT: mm
SURFACE DATA

| B | S | EA | R | d | glass | nd | νd |
|---|---|---|---|---|---|---|---|
| | OBJ | | | | | | |
| 1 | 1 | 52.86 | 54.8041 | 2.5000 | SLAH89 | 1.85150 | 40.78 |
| | 2 | 41.91 | 26.1910 | 6.3000 | | | |
| | 3 | 41.61 | 51.1936 | 2.3000 | LLAL15 | 1.69304 | 52.93 |
| | 4* | 35.96 | 19.9502 | 12.4800 | | | |
| | 5* | 30.92 | 237.3916 | 2.6000 | SLAH95 | 1.90366 | 31.34 |
| | 6 | 29.83 | 194.7316 | 7.3300 | | | |
| | 7 | 28.00 | −32.1785 | 1.6000 | SFPM2 | 1.59522 | 67.73 |
| | 8 | 28.89 | 38.5920 | 5.6000 | SNBH56 | 1.85478 | 24.80 |
| | 9 | 29.06 | −336.2204 | (7.1775) | | | |
| 2 | 10 | 29.32 | 125.4790 | 1.5000 | SNPH5 | 1.85896 | 22.73 |
| | 11 | 29.15 | 42.9695 | 7.3000 | SBSM14 | 1.60311 | 60.64 |
| | 12 | 29.35 | −47.4609 | (16.9373) | | | |
| 3 | 13 | 29.25 | 29.6448 | 1.5000 | TAFD55 | 2.00100 | 29.13 |
| | 14 | 27.96 | 22.2226 | 8.2000 | SNSL3 | 1.51823 | 58.90 |
| | 15 | 27.68 | −132.5812 | (2.1766) | | | |
| 4 | s16 | 17.00 | ∞ | 3.8300 | | | |
| | 17 | 22.90 | −49.8744 | 1.2000 | SLAH89 | 1.85150 | 40.78 |
| | 18 | 23.30 | 50.5772 | 4.0000 | EFDS1W | 1.92286 | 20.88 |
| | 19 | 23.54 | −498.2846 | (9.9588) | | | |
| 5 | 20 | 25.22 | 24.6944 | 6.2000 | SFPM2 | 1.59522 | 67.73 |
| | 21 | 24.99 | −325.3047 | 0.2000 | | | |
| | 22 | 24.58 | 42.0763 | 1.5000 | SLAH60 | 1.83400 | 37.16 |
| | 23 | 22.82 | 15.3362 | 8.4000 | SFPM2 | 1.59522 | 67.73 |
| | 24 | 22.65 | −78.8115 | 0.7800 | | | |
| | 25 | 22.38 | −105.2701 | 5.0000 | SNSL36 | 1.51742 | 52.43 |
| | 26 | 22.18 | −18.4462 | 1.0000 | NBFD29 | 1.77047 | 29.74 |
| | 27 | 22.77 | −2176.5164 | (6.5370) | | | |
| 6 | 28* | 23.73 | −110.7182 | 1.8000 | LLAH85V | 1.85400 | 40.38 |
| | 29* | 25.66 | 205.5464 | (1.2000) | | | |
| 7 | 30 | 38.21 | 120.0000 | 4.1000 | EFDS1W | 1.92286 | 20.88 |
| | 31 | 38.57 | −397.3916 | 17.1928 | | | |
| | IMG | | | | | | |

ASPHERIC DATA
surface 4
r = 1.99502e+01 K = −5.52483e−01 A = −7.91035e−06 B = −1.38810e−08
C = 4.17072e−12 D = −6.21938e−14 E = −2.32811e−16 F = 2.86624e−19
surface 5
r = 2.37392e+02 K = 0.00000e+00 A = −5.84004e−06 B = −9.83163e−09
C = 9.77778e−12 D = −1.48934e−13 E = 6.43223e−17 F = 0.00000e+00
surface 28
r = −1.10718e+02 K = 0.00000e+00 A = −1.05024e−04 B = 2.69301e−07
C = −3.07723e−10 D = 2.81210e−13 E = −6.41624e−15 F = 0.00000e+00
surface 29
r = 2.05546e+02 K = 0.00000e+00 A = −8.35550e−05 B = 3.38827e−07
C = −5.37040e−10 D = 0.00000e+00 E = 0.00000e+00 F = 0.00000e+00

VARIOUS DATA

| | WIDE | MIDDLE | TELE |
|---|---|---|---|
| Focal Length | 16.40 | 24.00 | 30.00 |
| Fno | 2.88 | 2.88 | 2.88 |
| AOV | 52.84 | 42.03 | 35.80 |
| PIH | 21.64 | 21.64 | 21.64 |
| RIH | 18.61 | 20.70 | 21.42 |
| TTL | 158.40 | 158.40 | 158.40 |
| BF | 17.19 | 17.19 | 17.19 |

Distance Data

| | WIDE | MIDDLE | TELE | WIDE | MIDDLE | TELE |
|---|---|---|---|---|---|---|
| OBJ | ∞ | ∞ | ∞ | 280 mm | 350 mm | 400 mm |
| d9 | 7.1775 | 1.7780 | 1.2000 | 9.2819 | 3.4208 | 2.5694 |
| d12 | 16.9373 | 11.0189 | 2.0000 | 14.1369 | 9.0421 | 0.3000 |
| d15 | 2.1766 | 11.0862 | 16.5829 | 2.8726 | 11.4201 | 16.9136 |
| d19 | 9.9588 | 2.8758 | 1.0000 | 9.9588 | 2.8758 | 1.0000 |
| d27 | 6.5370 | 5.1470 | 4.2451 | 6.5370 | 5.1470 | 4.2451 |
| d29 | 1.2000 | 12.0813 | 18.9592 | 1.2000 | 12.0813 | 18.9592 |

ZOOM LENS UNIT DATA

| Lens Unit | Starting Surface | Focal Length |
|---|---|---|
| B1 | 1 | −17.4381 |
| B2 | 10 | 74.0295 |
| B3 | 13 | 61.9737 |
| B4 | 16 | −72.9207 |
| B5 | 20 | 40.8428 |
| B6 | 28 | −84.0399 |
| B7 | 30 | 100.2545 |

NUMERICAL EXAMPLE 2
UNIT: mm
SURFACE DATA

| B | S | EA | R | d | glass | nd | νd |
|---|---|---|---|---|---|---|---|
| | OBJ | | | | | | |
| 1 | 1 | 59.38 | 66.1424 | 2.5000 | SLAH89 | 1.85150 | 40.78 |
| | 2 | 46.80 | 29.2487 | 5.6000 | | | |
| | 3 | 46.39 | 45.0000 | 2.3000 | SBAL42 | 1.58313 | 59.37 |
| | 4* | 41.06 | 20.5649 | 5.6000 | | | |
| | 5* | 40.18 | 42.6792 | 2.2000 | SLAH92 | 1.89190 | 37.13 |
| | 6 | 36.13 | 28.8740 | 10.4000 | | | |
| | 7 | 36.00 | −48.6042 | 1.6000 | SFPM2 | 1.59522 | 67.73 |
| | 8 | 37.64 | 40.3631 | 5.4000 | SNBH56 | 1.85478 | 24.80 |
| | 9 | 37.63 | 165.7629 | 0.2000 | | | |
| | 10 | 37.91 | 76.9297 | 4.5000 | SNBH8 | 1.72047 | 34.71 |
| | 11 | 37.67 | 1093.7021 | (19.6727) | | | |
| 2 | 12 | 33.89 | 113.1330 | 1.2000 | SNBH56 | 1.85478 | 24.80 |
| | 13 | 33.42 | 40.7656 | 7.5000 | SBSM28 | 1.61772 | 49.81 |
| | 14 | 33.38 | −67.7799 | (12.5960) | | | |
| 3 | 15 | 31.61 | 43.8442 | 4.3500 | SFPM2 | 1.59522 | 67.73 |
| | 16 | 30.83 | 108.8785 | (1.0000) | | | |
| 4 | 17 | 30.43 | 40.9083 | 1.2000 | TAFD55 | 2.00100 | 29.13 |
| | 18 | 29.17 | 24.2681 | 9.0000 | SBSL7 | 1.51633 | 64.14 |
| | 19 | 28.99 | −73.6596 | (5.8827) | | | |
| 5 | s20 | 14.76 | ∞ | 2.0000 | | | |
| | 21 | 21.91 | −56.2465 | 1.2000 | SLAH65V | 1.80400 | 46.58 |
| | 22 | 21.95 | 226.2022 | 1.6800 | | | |
| | 23 | 21.98 | −51.0367 | 1.2000 | SLAH66 | 1.77250 | 49.60 |
| | 24 | 23.21 | 41.1961 | 3.9500 | EFDS1W | 1.92286 | 20.88 |
| | 25 | 23.79 | −189.1545 | (13.1305) | | | |
| 6 | 26 | 27.71 | 27.7185 | 1.5000 | TAFD55W | 2.00100 | 29.13 |
| | 27 | 27.03 | 21.1557 | 8.6000 | SFPM3 | 1.53775 | 74.70 |
| | 28 | 27.51 | −83.7891 | 0.2000 | | | |
| | 29 | 28.03 | 53.7544 | 5.5000 | SFPM2 | 1.59522 | 67.73 |
| | 30 | 27.80 | −85.3802 | 0.2000 | | | |
| | 31 | 26.86 | 60.1813 | 5.2000 | SFPL51 | 1.49700 | 81.54 |
| | 32 | 26.24 | −44.3572 | 1.0000 | NBFD29 | 1.77047 | 29.74 |
| | 33 | 25.27 | 46.9107 | 3.4300 | | | |
| | 34* | 25.30 | 116.1760 | 1.8000 | LLAH85V | 1.85400 | 40.38 |
| | 35* | 26.45 | 50.0000 | (1.5000) | | | |
| 7 | 36 | 36.65 | 120.0000 | 4.5500 | SNSL36 | 1.51742 | 52.43 |
| | 37 | 37.17 | −153.1252 | (20.0054) | | | |
| | IMG | | | | | | |

ASPHERIC DATA
surface 4
r = 2.05649e+01 K = −6.38630e−01 A = − 8.16907e−06 B = −1.97414e−09
C = −4.67214e−11 D = 9.01843e−14 E = −2.35851e−16 F = 1.72266e−19
surface 5
r = 4.26792e+01 K = 0.00000e+00 A = −5.17486e−06 B = −3.03735e−09
C = −1.14335e−11 D = −5.94349e−15 E = 0.00000e+00 F = 0.00000e+00
surface 34
r = 1.16176e+02 K = 0.00000e+00 A = −1.04238e−04 B = 2.17055e−07
C = −7.97888e−11 D = 1.39933e−13 E = −1.27150e−15 F = 0.00000e+00
surface 35
r = 5.00000e+01 K = 0.00000e+00 A = −9.17868e−05 B = 2.94581e−07
C = −2.71975e−10 D = 0.00000e+00 E = 0.00000e+00 F = 0.00000e+00

VARIOUS DATA

| | WIDE | MIDDLE | TELE |
|---|---|---|---|
| Focal Length | 15.40 | 24.00 | 34.50 |
| Fno | 2.88 | 2.88 | 2.88 |
| AOV | 54.55 | 42.03 | 32.09 |
| PIH | 21.64 | 21.64 | 21.64 |
| RIH | 18.61 | 21.26 | 22.06 |
| TTL | 179.35 | 179.35 | 179.35 |
| BF | 20.01 | 17.65 | 25.54 |

Distance Data

| | WIDE | MIDDLE | TELE | WIDE | MIDDLE | TELE |
|---|---|---|---|---|---|---|
| OBJ | ∞ | ∞ | ∞ | 280 mm | 350 mm | 400 mm |
| d11 | 19.6727 | 5.1155 | 1.0000 | 23.2631 | 7.8710 | 3.1338 |
| d14 | 12.5960 | 15.4151 | 2.0000 | 6.9721 | 12.3169 | 0.3000 |
| d16 | 1.0000 | 1.0000 | 6.7950 | 3.0334 | 1.3426 | 6.3616 |
| d19 | 5.8827 | 13.2865 | 19.7386 | 5.8827 | 13.2865 | 19.7386 |
| d25 | 13.1305 | 6.1448 | 1.2000 | 13.1305 | 6.1448 | 1.2000 |
| d35 | 1.5000 | 15.1705 | 17.5168 | 1.5000 | 15.1705 | 17.5168 |
| d37 | 20.0054 | 17.6548 | 25.5365 | 20.0054 | 17.6548 | 25.5365 |

ZOOM LENS UNIT DATA

| Lens Unit | Starting Surface | Focal Length |
|---|---|---|
| B1 | 1 | −20.9626 |
| B2 | 12 | 92.9094 |
| B3 | 15 | 120.3173 |
| B4 | 17 | 86.9686 |
| B5 | 20 | −41.2219 |
| B6 | 26 | 41.7900 |
| B7 | 36 | 130.7674 |

NUMERICAL EXAMPLE 3
UNIT: mm
SURFACE DATA

| B | S | EA | R | d | glass | nd | νd |
|---|---|---|---|---|---|---|---|
| | OBJ | | | | | | |
| 1 | 1 | 52.09 | 59.2027 | 2.5000 | SLAH89 | 1.85150 | 40.78 |
| | 2 | 40.35 | 25.2169 | 5.0500 | | | |
| | 3 | 39.96 | 40.0000 | 2.5000 | SLAH65V | 1.80400 | 46.58 |
| | 4* | 34.25 | 18.0788 | 13.2500 | | | |
| | 5* | 29.09 | −138.6637 | 2.5000 | TAFD25 | 1.90366 | 31.31 |
| | 6 | 28.38 | 1829.7489 | 3.6500 | | | |
| | 7 | 28.03 | −40.1475 | 1.4000 | SFPM2 | 1.59522 | 67.73 |
| | 8 | 28.57 | 36.3384 | 5.1000 | SNBH56 | 1.85478 | 24.80 |
| | 9 | 28.47 | −689.0235 | (8.8779) | | | |
| 2 | 10 | 27.46 | 63.6216 | 1.5000 | SNPH5 | 1.85896 | 22.73 |
| | 11 | 26.98 | 36.5502 | 6.6000 | SFSL5 | 1.48749 | 70.24 |
| | 12 | 27.12 | −45.8745 | (11.4346) | | | |
| 3 | 13 | 27.54 | 38.3060 | 3.6000 | SFPL51 | 1.49700 | 81.54 |
| | 14 | 27.33 | 98.2355 | (1.3653) | | | |
| 4 | 15 | 27.55 | 40.0573 | 1.5000 | TAFD55 | 2.00100 | 29.13 |
| | 16 | 26.55 | 23.7272 | 7.3500 | STIL2 | 1.54072 | 47.23 |
| | 17 | 26.49 | −69.6732 | (2.0280) | | | |
| 5 | s18 | 15.67 | ∞ | 3.6200 | | | |
| | 19 | 21.23 | −51.0515 | 1.2000 | TAFD30 | 1.88300 | 40.80 |
| | 20 | 22.05 | 36.9523 | 4.1000 | EFDS1W | 1.92286 | 20.88 |
| | 21 | 22.74 | 742.6839 | (14.8364) | | | |
| 6 | 22 | 26.80 | 24.8694 | 6.8200 | SFPM2 | 1.59522 | 67.73 |
| | 23 | 26.47 | −218.3764 | 0.2000 | | | |
| | 24 | 25.75 | 31.3592 | 1.5000 | SLAH88 | 1.91650 | 31.60 |
| | 25 | 23.55 | 15.2512 | 8.1000 | SFPM2 | 1.59522 | 67.73 |
| | 26 | 23.06 | 992.4468 | 1.4500 | | | |
| | 27 | 22.84 | −110.8411 | 5.8000 | SBAL12 | 1.53996 | 59.46 |
| | 28 | 22.63 | −16.6080 | 1.0000 | NBFD29 | 1.77047 | 29.74 |
| | 29 | 23.50 | −301.5408 | (5.0672) | | | |
| 7 | 30* | 24.37 | −534.6150 | 1.8000 | LLAH85V | 1.85400 | 40.38 |
| | 31* | 26.16 | 120.0000 | (1.2000) | | | |
| 8 | 32 | 35.37 | 236.2095 | 3.6500 | EFDS1W | 1.92286 | 20.88 |
| | 33 | 36.00 | −164.5918 | (13.9496) | | | |
| | IMG | | | | | | |

ASPHERIC DATA
surface 4
r = 1.80788e+01 K = −2.08409e−01 A = −1.40681e−05 B = −3.21992e−08
C = −1.45149e−11 D = −3.21578e−13 E = 3.99325e−16 F = −2.03118e−18
surface 5
r = −1.38664e+02 K = 0.00000e+00 A = −7.94693e−06 B = −1.84773e−08
C = 3.72751e−11 D = −3.91728e−13 E = 2.17993e−16 F = 0.00000e+00
surface 30
r = −5.34615e+02 K = 0.00000e+00 A = −9.84401e−05 B = 2.34528e−07
C = −5.20812e−10 D = 3.27435e−12 E = −1.52726e−14 F = 0.00000e+00
surface 31
r = 1.20000e+02 K = 0.00000e+00 A = −7.53437e−05 B = 2.65764e−07
C = −1.51236e−10 D = −6.71234e−13 E = 0.00000e+00 F = 0.00000e+00

VARIOUS DATA

| | WIDE | MIDDLE | TELE |
|---|---|---|---|
| Focal Length | 14.42 | 20.00 | 27.40 |
| Fno | 2.88 | 2.88 | 2.88 |
| AOV | 56.31 | 47.25 | 38.30 |
| PIH | 21.64 | 21.64 | 21.64 |
| RIH | 18.61 | 20.71 | 22.06 |
| TTL | 154.50 | 154.50 | 154.50 |
| BF | 13.95 | 15.21 | 18.90 |

Distance Data

| | WIDE | MIDDLE | TELE | WIDE | MIDDLE | TELE |
|---|---|---|---|---|---|---|
| OBJ | ∞ | ∞ | ∞ | 280 mm | 350 mm | 400 mm |
| d9 | 8.8779 | 1.7644 | 1.0000 | 10.8108 | 3.2406 | 2.3866 |
| d12 | 11.4346 | 13.0911 | 2.9539 | 8.0026 | 10.8666 | 0.3000 |
| d14 | 1.3653 | 1.0000 | 1.7878 | 2.8645 | 1.7482 | 3.0552 |
| d17 | 2.0280 | 7.8507 | 17.9639 | 2.0280 | 7.8507 | 17.9639 |
| d21 | 14.8364 | 6.2452 | 1.0000 | 14.8364 | 6.2452 | 1.0000 |
| d29 | 5.0672 | 5.5077 | 3.8729 | 5.0672 | 5.5077 | 3.8729 |
| d31 | 1.2000 | 8.0916 | 11.2788 | 1.2000 | 8.0916 | 11.2788 |
| d33 | 13.9496 | 15.2083 | 18.9010 | 13.9496 | 15.2083 | 18.9010 |

ZOOM LENS UNIT DATA

| Lens Unit | Starting Surface | Focal Length |
|---|---|---|
| B1 | 1 | −14.6826 |
| B2 | 10 | 72.4807 |
| B3 | 13 | 123.8691 |
| B4 | 15 | 74.9138 |
| B5 | 18 | −57.1268 |
| B6 | 22 | 39.5804 |
| B7 | 30 | −114.6116 |
| B8 | 32 | 105.5706 |

NUMERICAL EXAMPLE 4
UNIT: mm
SURFACE DATA

| B | S | EA | R | d | glass | nd | νd |
|---|---|---|---|---|---|---|---|
| | OBJ | | | | | | |
| 1 | 1 | 56.89 | 59.6831 | 2.5000 | SLAH88 | 1.91650 | 31.60 |
| | 2 | 45.16 | 28.2244 | 4.7300 | | | |
| | 3 | 44.80 | 40.0000 | 2.3000 | SLAL14 | 1.69680 | 55.53 |
| | 4* | 38.15 | 20.3201 | 6.8000 | | | |
| | 5* | 37.91 | 50.3556 | 2.3000 | SLAH93 | 1.90525 | 35.04 |
| | 6 | 34.83 | 30.2873 | 8.9300 | | | |
| | 7 | 34.71 | −63.0516 | 1.6000 | SLAL12Q | 1.67790 | 55.35 |
| | 8 | 36.14 | 34.5393 | 7.1000 | SNBH56 | 1.85478 | 24.80 |
| | 9 | 36.20 | 261.3543 | 0.2000 | | | |
| | 10 | 36.49 | 75.4467 | 3.4000 | STIH53 | 1.84666 | 23.78 |
| | 11 | 36.15 | 133.6277 | (12.5565) | | | |
| 2 | 12 | 35.80 | 55.1695 | 1.5000 | SNPH5 | 1.85896 | 22.73 |
| | 13 | 34.79 | 30.7739 | 8.9000 | SNBH5 | 1.65412 | 39.68 |
| | 14 | 34.81 | −98.4237 | (26.3663) | | | |
| 3 | 15 | 33.36 | 41.3530 | 1.5000 | TAFD55 | 2.00100 | 29.13 |
| | 16 | 31.98 | 27.8439 | 9.8000 | SFSL5 | 1.48749 | 70.24 |
| | 17 | 31.80 | −57.2376 | (2.0000) | | | |
| 4 | s18 | 16.77 | ∞ | 2.0000 | | | |
| | 19 | 25.17 | 23.6438 | 3.0500 | SFPM3 | 1.53775 | 74.70 |
| | 20 | 24.05 | 29.2192 | 4.5700 | | | |
| | 21 | 23.96 | −42.1852 | 1.2000 | SLAH92 | 1.89190 | 37.13 |
| | 22 | 24.47 | 31.1615 | 4.2000 | EFDS1W | 1.92286 | 20.88 |
| | 23 | 24.64 | 260.9278 | (9.4139) | | | |
| 5 | 24 | 25.93 | 34.6788 | 1.5000 | SLAH95 | 1.90366 | 31.34 |
| | 25 | 25.52 | 20.8116 | 8.1000 | SFPM3 | 1.53775 | 74.70 |
| | 26 | 26.50 | −71.9648 | 0.2000 | | | |
| | 27 | 29.04 | 30.8001 | 8.2000 | SFPM2 | 1.59522 | 67.73 |
| | 28 | 28.76 | −51.2140 | (1.6134) | | | |
| 6 | 29 | 26.90 | −229.5965 | 3.7000 | SNPH5 | 1.85896 | 22.73 |
| | 30 | 26.33 | −51.2136 | 1.0000 | NBFD29 | 1.77047 | 29.74 |
| | 31 | 24.98 | 38.1643 | 4.1000 | | | |
| | 32* | 24.99 | −331.2751 | 1.8000 | LLAH85V | 1.85400 | 40.38 |
| | 33* | 26.02 | 110.0000 | (1.2000) | | | |
| 7 | 34 | 37.67 | 135.8342 | 4.6000 | STIL2 | 1.54072 | 47.23 |
| | 35 | 38.21 | −150.8802 | (16.7700) | | | |
| | IMG | | | | | | |

ASPHERIC DATA
surface 4
r = 2.03201e+01 K = −4.40911e−01 A = −2.49618e−06 B = −5.16534e−09
C = 2.15461e−11 D = −1.41245e−13 E = 3.48943e−16 F = −3.74156e−19
surface 5
r = 5.03556e+01 K = 0.00000e+00 A = −2.25139e−06 B = 1.90669e−10
C = −6.15158e−12 D = 1.79381e−14 E = −2.26347e−17 F = 0.00000e+00
surface 32
r = −3.31275e+02 K = 0.00000e+00 A = −1.21024e−04 B = 3.97839e−07
C = 2.86516e−10 D = −2.67375e−12 E = 2.31235e−15 F = 0.00000e+00
surface 33
r = 1.10000e+02 K = 0.00000e+00 A = −1.00095e−04 B = 5.14427e−07
C = −6.10752e−10 D = 0.00000e+00 E = 0.00000e+00 F = 0.00000e+00

VARIOUS DATA

| | WIDE | MIDDLE | TELE |
|---|---|---|---|
| Focal Length | 15.40 | 24.00 | 34.50 |
| Fno | 2.88 | 2.88 | 2.88 |
| AOV | 54.55 | 42.03 | 32.09 |
| PIH | 21.64 | 21.64 | 21.64 |
| RIH | 18.61 | 21.04 | 22.06 |
| TTL | 179.70 | 179.70 | 179.70 |
| BF | 16.77 | 19.64 | 20.70 |

Distance Data

| | WIDE | MIDDLE | TELE | WIDE | MIDDLE | TELE |
|---|---|---|---|---|---|---|
| OBJ | ∞ | ∞ | ∞ | 280 mm | 350 mm | 400 mm |
| d11 | 12.5565 | 1.2363 | 1.0000 | 14.9466 | 3.0633 | 2.2964 |
| d14 | 26.3663 | 18.3489 | 2.0000 | 23.5414 | 16.7524 | 2.6901 |
| d17 | 2.0000 | 12.7636 | 20.0679 | 2.4348 | 12.5331 | 18.0814 |
| d23 | 9.4139 | 4.2982 | 1.2000 | 9.4139 | 4.2982 | 1.2000 |
| d28 | 1.6134 | 1.9397 | 1.2000 | 1.6134 | 1.9397 | 1.2000 |
| d33 | 1.2000 | 11.6882 | 23.7548 | 1.2000 | 11.6882 | 23.7548 |
| d35 | 16.7700 | 19.6446 | 20.6962 | 16.7700 | 19.6446 | 20.6962 |

ZOOM LENS UNIT DATA

| Lens Unit | Starting Surface | Focal Length |
|---|---|---|
| B1 | 1 | −17.6659 |
| B2 | 12 | 65.6278 |
| B3 | 15 | 70.8286 |
| B4 | 18 | −58.7680 |
| B5 | 24 | 23.4941 |
| B6 | 29 | −29.4723 |
| B7 | 34 | 132.9449 |

Table 1 summarizes various values of inequalities in each example.

TABLE 1

| INEQUALITY | | EXAMPLE1 | EXAMPLE2 | EXAMPLE3 | EXAMPLE4 |
|---|---|---|---|---|---|
| (1) | mo1w/mo2w | 0.3308 | 0.5663 | 0.7755 | 0.1820 |
| (2) | movF1/TTL | 0.0376 | 0.1043 | 0.0506 | 0.0644 |
| (3) | ff/fr | 0.3490 | 0.2538 | 0.2725 | 0.3646 |
| (4) | fF1/fF2 | 1.1945 | 0.7722 | 0.5851 | 0.9266 |
| (5) | BF/fw | 0.9884 | 1.2617 | 0.9362 | 1.0597 |

Table 2 summarizes various values (degrees) of angles of views in each example.

TABLE 2

| | | WIDE | MIDDLE | TELE |
|---|---|---|---|---|
| EXAMPLE | ∞ | 52.84 | 42.03 | 35.80 |
| 1 | NEAR | 52.84 | 42.04 | 35.80 |
| EXAMPLE | ∞ | 54.55 | 42.03 | 32.09 |
| 2 | NEAR | 54.56 | 42.03 | 32.18 |
| EXAMPLE | ∞ | 56.31 | 47.25 | 38.30 |
| 3 | NEAR | 56.31 | 47.26 | 38.23 |
| EXAMPLE | ∞ | 54.55 | 42.03 | 32.09 |
| 4 | NEAR | 54.55 | 42.03 | 32.70 |

Table 3 summarizes magnification variations (%) in each example.

TABLE 3

| | WIDE | MIDDLE | TELE |
|---|---|---|---|
| EXAMPLE 1 | 0.00 | 0.02 | 0.00 |
| EXAMPLE 2 | 0.01 | 0.00 | 0.35 |
| EXAMPLE 3 | 0.01 | 0.03 | −0.24 |
| EXAMPLE 4 | 0.00 | −0.01 | 2.36 |

### Image Pickup Apparatus

Referring now to FIG. 9, a description will be given of an image pickup apparatus 200 having a zoom lens according to each example. FIG. 9 is a schematic diagram of the image pickup apparatus 200. In FIG. 9, reference numeral 50 denotes a camera body, and reference numeral 100 denotes a lens apparatus having a zoom lens according to any one of the above examples. Reference numeral 60 denotes an image sensor (photoelectric conversion element), such as a CMOS sensor or a CCD sensor, which is built into the camera body 50 and receives an optical image formed by the zoom lens in the lens apparatus 100 and photoelectrically converts it. The camera body 50 may be a so-called single-lens reflex camera that has a quick turn mirror, or a so-called mirrorless camera that does not have a quick turn mirror. The zoom lens according to any one of the above examples is applicable not only to a digital still camera but also to another image pickup apparatus such as a video camera.

The zoom lens according to each example has few aberrational fluctuations during zooming, has high optical performance over the entire object distance, and little changes in the angle of view during focusing. Therefore, each example can provide a zoom lens and an image pickup apparatus each having high optical performance.

While the disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2023-114131, which was filed on Jul. 12, 2023, and which is hereby incorporated by reference herein in its entirety.

What is claimed is:

1. A zoom lens comprising a plurality of lens units, the plurality of lens units consisting of, in order from an object side to an image side:
a first lens unit having negative refractive power;
an intermediate group having positive refractive power, the intermediate group including two or more lens units;
an aperture stop; and
a rear group including at least one lens unit,
wherein a distance between adjacent lens units changes during zooming from a wide-angle end to a telephoto end, and
wherein the intermediate group includes a first focus unit and a second focus unit that move during focusing from infinity to a close distance.

2. The zoom lens according to claim 1, wherein the first focus unit and the second focus unit move in different directions during focusing from infinity to the close distance at the wide-angle end.

3. The zoom lens according to claim 1, wherein the first focus unit moves toward the image side, and the second focus unit moves toward the object side during focusing from infinity to the close distance at the wide-angle end.

4. The zoom lens according to claim 1, wherein the following inequality is satisfied:
$$0. < \vert mo 2 w \vert / \vert mo 1 w \vert < 1.$$
where mo1w is a moving amount of the first focus unit and mo2w is a moving amount of the second focus unit during focusing from infinity to the close distance at the wide-angle end.

5. The zoom lens according to claim 1, wherein the following inequality is satisfied:
$$0. < mov F 1 / TTL < 0.15$$
where movF1 is a zoom moving amount of the first focus unit relative to the first lens unit, and TTL is a distance from a lens surface closest to an object of the zoom lens to an image plane.

6. The zoom lens according to claim 1, wherein the following inequality is satisfied:
$$0. 20 < ff / fr < 1.$$
where ff is a combined focal length of lens units disposed on the object side of the aperture stop among the zoom lens, and ff is a combined focal length of lens units disposed on the image side of the aperture stop.

7. The zoom lens according to claim 1, wherein the following inequality is satisfied:
$$0.3 < fF 1 / fF 2 < 1.7$$
where fF1 is a focal length of the first focus unit, and fF2 is a focal length of the second focus unit.

8. The zoom lens according to claim 1, wherein during zooming from the wide-angle end to the telephoto end, the first lens unit is fixed relative to an image plane, and the first focus unit and the second focus unit move toward the object side.

9. The zoom lens according to claim 1, wherein the rear group includes a negative lens unit, and a positive lens unit that moves from the image side to the object side during zooming.

10. The zoom lens according to claim 1, wherein the rear group includes a lens unit having positive refractive power and disposed closest to an image plane, and
wherein the following inequality is satisfied:
$$0. 2 < BFw / fw < 2.0$$
where BFw is an air equivalent length of a back focus at the wide-angle end, and fw is a focal length of the zoom lens at the wide-angle end.

11. An image pickup apparatus comprising:
a zoom lens; and
an image sensor,
wherein the zoom lens includes a plurality of lens units, the plurality of lens units consisting of, in order from an object side to an image side:
a first lens unit having negative refractive power;
an intermediate group having positive refractive power, the intermediate group including two or more lens units;
an aperture stop; and
a rear group including at least one lens unit,
wherein a distance between adjacent lens units changes during zooming from a wide-angle end to a telephoto end, and
wherein the intermediate group includes a first focus unit and a second focus unit that move during focusing from infinity to a close distance.
